(19) United States
(12) Patent Application Publication
(10) Pub. No.: US 2022/0154974 A1
(43) Pub. Date: May 19, 2022

(54) METHOD AND ARRANGEMENT

(71) Applicant: Valmet Technologies Oy, Espoo (FI)

(72) Inventor: Mikko PAAVOLA, Tampere (FI)

(21) Appl. No.: 17/526,366

(22) Filed: Nov. 15, 2021

(30) Foreign Application Priority Data
Nov. 16, 2020 (FI) 20206158

(51) Int. Cl. F24H 1/44; F24H 8/00; F24D 3/18; F24D 10/00; F24D 19/10

(52) U.S. Cl. CPC F24H 1/445; F24H 8/00; F24H 8/003; F24D 10/00; F24D 19/1039; F24D 3/18

(57) ABSTRACT

A method and an arrangement for recovering heat from flue gas of a boiler (10). The method comprises passing the flue gas (G) of the boiler though a flue gas cooling unit (1), cooling the flue gas (G) by transferring heat from the flue gas (G) into a circulation (3) of a flue gas cooling liquid (CL), transferring heat energy of said flue gas cooling liquid (CL) into a heat pump (2), and arranging the heat pump (2) for receiving heat energy also from a circulation arrangement (8) of a district cooling system. The heat pump (2) is coupled to a circulation arrangement (6) of a district heating system, wherein the method further comprises transferring in the heat pump (2) heat energy (H) received from said cooling liquid (CL) and from said circulation arrangement (8) of district cooling system into said circulation arrangement (6) of district heating system, for lowering the temperature of said flue gas cooling liquid (CL) and cooling fluid of said district cooling system, and raising the temperature of heating fluid of said district heating system.

### CROSS-REFERENCE TO RELATED APPLICATIONS

This application claims benefit of Finnish Application No. 20206158, filed 16 Nov. 2020, and which application is incorporated herein by reference. To the extent appropriate, a claim of priority is made to the above-disclosed application.

### BACKGROUND

The invention relates to a method for recovering heat from flue gas of a boiler.

The invention further relates to an arrangement for recovering heat from flue gas of a boiler.

It is known to use flue gas washing and condensing systems, such as condensers and scrubbers, in combustion plants for recovering heat from flue gas which is produced in the combustion of a fuel. In a flue gas scrubber, the flue gas is cooled by scrubbing water so that water vapour contained in the flue gas condenses and the released condensing heat may be utilized, for instance, in a district heating plant where the condensing heat is used to heat district heating water. The scrubbing water is circulated through a heat exchanger where heat energy is transferred into district heating water.

It is also known to connect a heat pump between a supply channel feeding heated water in a district heating network and a return channel supplying district heating water returning from the district heating network back into the heat exchanger for heating. The heat pump is configured to heat the district heating water in the supply channel by using heat energy of water running in the return channel. An advantage is that cooler water is supplied in the heat exchanger and thus flue gases can be condensed to a lower temperature.

Typical district heating power plants in the Nordics adjust their load depending on the outside temperature. Power plant load is decreased towards the summer season and when minimum loads are needed flue gas heat recovery plants are shut down or the effect has been minimized to reach low load for the plant. Thus, the overall energy efficiency of the plant is lowered in summer season.

### BRIEF DESCRIPTION

Viewed from a first aspect, there can be provided a method for recovering heat from flue gas of a boiler, the method comprising
passing the flue gas of the boiler though a flue gas cooling unit,
cooling the flue gas in the flue gas cooling unit, said cooling comprising transferring heat from the flue gas into a circulation of a flue gas cooling liquid,
transferring heat energy of said flue gas cooling liquid heated in the flue gas cooling unit into a heat pump,
arranging the heat pump for receiving heat energy also from a circulation arrangement of a district cooling system, wherein
the heat pump is coupled to a circulation arrangement of a district heating system, wherein the method further comprises transferring in the heat pump heat energy received
   from said cooling liquid and
   from said circulation arrangement of district cooling system
   into said circulation arrangement of district heating system, for
   lowering the temperature of said flue gas cooling liquid and cooling fluid of said district cooling system, and
   raising the temperature of heating fluid of said district heating system.

Thereby a method having high energy efficiency year-round may be achieved.

Viewed from a further aspect, there can be provided an arrangement for recovering heat from flue gas of a boiler, the arrangement comprising a flue gas cooling unit, configured to cool the flue gas with a flue gas cooling liquid, a heat pump coupled to the flue gas cooling unit, to a circulation arrangement of a district cooling system, and to a circulation arrangement of a district heating system, the heat pump arranged to receive flue gas cooling liquid heated in said flue gas cooling unit, district cooling fluid from the circulation arrangement of a district cooling system, and district heating fluid from the circulation arrangement of a district heating system, the heat pump configured for receiving heat energy from the flue gas cooling liquid, for receiving heat energy from the district cooling fluid, and for raising temperature of the district heating fluid.

Thereby an arrangement having high energy efficiency year-round may be achieved.

The arrangement and the method are characterised by what is stated in the independent claims. Some other embodiments are characterised by what is stated in the other claims. Inventive embodiments are also disclosed in the specification and drawings of this patent application. The inventive content of the patent application may also be defined in other ways than defined in the following claims. The inventive content may also be formed of several separate inventions, especially if the invention is examined in the light of expressed or implicit sub-tasks or in view of obtained benefits or benefit groups. Some of the definitions contained in the following claims may then be unnecessary in view of the separate inventive ideas. Features of the different embodiments of the invention may, within the scope of the basic inventive idea, be applied to other embodiments.

In one embodiment, the flue gas cooling unit comprises a flue gas scrubber.

An advantage is that a high capacity of cooling may be achieved with an inexpensive way.

In one embodiment, the flue gas cooling liquid is circulating through a plurality of heat exchange zones of the flue gas scrubber.

An advantage is that capacity of cooling may further be achieved with an inexpensive way.

In one embodiment, the flue gas cooling unit comprises a tube heat exchanger.

An advantage is that the flue gas cooling unit has a low electricity consumption and a compact size that facilities designing the layout of the cooling unit.

In one embodiment, the arrangement comprises a combustion air humidifier, and the method comprises feeding flue gas cooling liquid from the flue gas cooling unit into a combustion air humidifier, heating and moisturizing combustion air to be fed in the boiler by heat energy of said flue gas cooling liquid in said combustion air humidifier, and exiting flue gas cooling liquid cooled in the combustion air humidifier from said combustion air humidifier, the method further comprising transferring heat energy of flue gas cooling liquid exiting the combustion air humidifier into the heat pump.

An advantage is that condensation of the water vapor and amount of heat energy released and recovered in the scrubbing water may be promoted.

In one embodiment, the flue gas cooling liquid is fed in the heat pump and circulated back therefrom to the flue gas cooling unit.

An advantage is that a very simple structure of arrangement may be achieved.

In one embodiment, the flue gas cooling liquid is fed in a heat exchanger, and in the heat exchanger heat energy from the flue gas cooling liquid is transferred into a transfer liquid circulating between the heat exchanger and the heat pump.

An advantage is that the heat pump is isolated from the flue gas cooling liquid that may be highly corrosive, and thus the heat pump may be manufactured from less expensive materials.

In one embodiment, the heat pump is an electrical heat pump.

An advantage is that the heat pump is simple and has compact outer dimensions.

In one embodiment, the heat pump is an absorption heat pump (AHP).

An advantage is that it is inexpensive to run the AHP since its electricity consumption is low and free heat energy is available from the boiler.

In one embodiment, steam and/or hot water is fed in a generator of the AHP for driving the AHP.

An advantage is that the heat pump may be driven with an inexpensive way.

In one embodiment, all the district heating fluid coming from the circulation arrangement of district heating system is fed in the heat pump.

An advantage is that capacity of transferring heat energy from the flue gas cooling unit and the district cooling system to the district heating system may be extended.

In one embodiment, only a part of the district heating fluid coming from the circulation arrangement of district heating system is fed in the heat pump, and rest of said district heating fluid is fed past the heat pump.

An advantage is that size of the heat pump may be kept reasonable even if the district heating system is large.

### BRIEF DESCRIPTION OF FIGURES

Some embodiments illustrating the present disclosure are described in more detail in the attached drawings, in which

FIG. 1 is a schematic side view of an arrangement and method for recovering heat from flue gas of a boiler,

FIG. 2 is a schematic side view of another arrangement and method for recovering heat from flue gas of a boiler,

FIG. 3 is a schematic side view of a third arrangement and method for recovering heat from flue gas of a boiler, and

FIG. 4 is a schematic side view of a fourth arrangement and method for recovering heat from flue gas of a boiler.

In the figures, some embodiments are shown simplified for the sake of clarity. Similar parts are marked with the same reference numbers in the figures.

### DETAILED DESCRIPTION

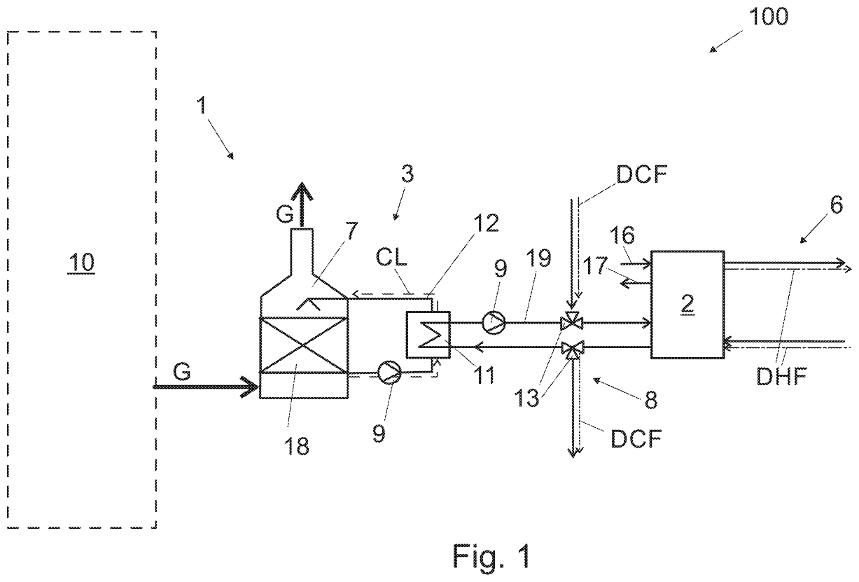

FIG. 1 is a schematic side view of an arrangement and method for recovering heat from flue gas of a boiler.

In the embodiment shown in FIG. 1, the boiler 10 is a heating boiler that burns a combustion process fuel, such as biomass or fossil fuel. The heat energy that is released in the combustion of the fuel is used to heat water that flows in a district heating network through a circulation arrangement of district heating water 6.

However, it is to be noted, that the arrangement and the method may be applied in various types of combustion plants. The boiler may be, for instance, any type of chemical recovery boiler, fluidized bed boiler, pulverized coal fired boiler, gas fired boiler, pulverized pellet fired boiler, etc. The arrangement and the method may also be applied in combustion engines.

The arrangement 100 comprises a flue gas cooling unit 1 that is configured to cool the flue gas G with a cooling liquid CL.

In the embodiment shown in FIG. 1, the flue gas cooling unit 1 comprises a flue gas condenser, such as a flue gas scrubber 7 wherein the cooling liquid CL comprises scrubbing water.

It is to be noted here, that in some embodiments the flue gas cooling unit 1 comprises a tube heat exchanger, wherein the cooling takes place by a circulation liquid.

In the flue gas scrubber 7, the flue gas is passed through one or more heat exchange zone(s) or packing zone(s). The flue gas scrubber 7 shown in FIG. 1 comprises one packing zone 18. The packing zone comprises a random packing bed acting as a heat and mass transfer surface.

The flue gas G is cooled by spraying scrubbing water over the packing zone 18 and heat energy is released from the flue gas and recovered into the scrubbing water.

The amount of heat energy that is released in the scrubbing process depends on the temperature of the scrubbing water, the dew point of the flue gas, as well as flue gas temperature and composition, available cooling liquid flow and temperature, such as temperature of district heating return water, connections and design of the complete system, and components and concepts thereof. The dew point depends on the moisture content of the flue gas. If the flue gas can be cooled under its dew point, the water vapor contained in the flue gas condenses and a large amount of heat energy is released and recovered into the scrubbing water.

The arrangement 100 further comprises a heat pump 2 that is coupled to the flue gas cooling unit 1. In one embodiment, such as shown in FIG. 1, the heat pump 2 is coupled to the flue gas cooling unit 1 by a heat exchanger 11. The flue gas cooling liquid CL is circulated by using one or more pump(s) 9 from the flue gas cooling unit 1 into the heat exchanger 11, and then back to the flue gas cooling unit 1. In the heat exchanger 11 heat from the flue gas cooling liquid CL is transferred into a transfer liquid circulating in a transfer piping 19 between the heat exchanger 11 and the heat pump 2.

In another embodiment, there is no heat exchanger 11 but the flue gas cooling liquid CL (or at least part of it) is fed in the heat pump 2.

The heat pump 2 is also connected to a circulation arrangement 6 of district heating system for receiving district heating fluid DHF, such as heating water of the district heating water system. The circulation arrangement 6 feeds heating water returning from a district heating network (not shown) used for heating e.g. residential and commercial objects in the heat pump 2.

Additionally, the heat pump 2 is connected to a circulation arrangement 8 of district cooling system for receiving district heating fluid DCF, such as cooling water of the district cooling system. The circulation arrangement 8 feeds cooling water returning from a district cooling network (not shown) used for cooling e.g. residential and commercial objects in the heat pump 2.

Thus, the heat pump 2 is arranged to receive heat energy of the flue gas cooling liquid CL heated in the flue gas cooling unit 1, and heat energy of the district cooling fluid heated in the district cooling network. The received heat energy is used for raising temperature of the district heating fluid DHF.

In one embodiment, such as shown in FIG. 1, the heat pump 2 is an absorption heat pump (AHP). The concept of the AHP is known per se. It may comprise a generator, an evaporator, an absorber and a condenser. Two fluids that function as an absorption medium and a refrigerant are arranged in the AHP. The principle of operation of the AHP is based on absorption and evaporation of the refrigerant. In one embodiment, the refrigerant is ammonia and the absorption medium is water (NH₃/H₂O).

In one embodiment, the generator of the heat pump is connected to a source of steam and/or hot water, such as the boiler 10 or another source, by a feed 16 of steam and/or hot water. Energy of the steam and/or hot water is used for running the AHP. Cooled steam and/or hot water may be returned to its source by a return 17 of feed.

In one embodiment, the evaporator of the heat pump is arranged for receiving heat from the flue gas cooling liquid CL, as described in this description. Heat energy received in the evaporator is transferred to the absorber of the heat pump by reactions of the second fluids. In the absorber, heat energy is transferred to the district heating fluid DHF that has cooled down in the circulation arrangement 6 of district heating system. The district heating fluid DHF is also directed through the condenser of the heat pump, in which the second fluid is adapted to condense from gas phase to liquid phase.

In another embodiment, the heat pump 2 is an electrical heat pump that comprises an electrical motor-driven compressor for driving the heat pump. In this embodiment, the feed 16 of steam and/or hot water and the return 17 of feed are not necessary.

A circulation arrangement 8 of district cooling system is connected to the heat pump 2 such that heat energy of district cooling fluid DCF coming from a district cooling network (not shown) and heated therein is transferred similarly as heat energy from the flue gas cooling liquid CL in the heat pump. The district cooling fluid DCF cools in the heat pump 2 and returned back in the circulation arrangement 8 of district cooling system.

In one embodiment, such as shown in FIG. 1, the circulation arrangement 8 of district cooling system is connected to the transfer piping 19, i.e. district cooling fluid DCF is fed together with transfer fluid in the heat pump 2, and cooled fluid is returned from the transfer piping 19 to the circulation arrangement 8 of district cooling system.

In another embodiment, the circulation arrangement 8 of district cooling system is connected via a heat exchanger to the heat pump 2.

In one embodiment, the circulation arrangement 6 of district heating system is separate from the circulation arrangement 8 of district cooling system.

In another embodiment, the circulation arrangement 8 of district cooling system is arranged to cool the same residential and commercial objects which the circulation arrangement of district heating system 6 is heating. In another embodiment, the circulation arrangement 8 of district cooling system is connected to another residential and commercial objects as the circulation arrangement of district heating system 6.

In one embodiment, such as shown in FIG. 1, the circulation arrangement 6 of district heating system is connected to the heat pump 2 such that all the district heating fluid DHF is circulating through the heat pump 2.

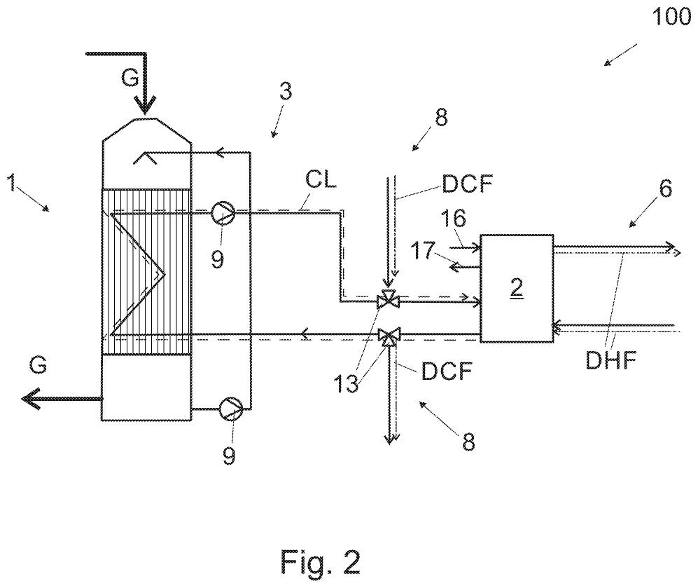

FIG. 2 is a schematic side view of another arrangement and method for recovering heat from flue gas of a boiler.

In one embodiment, such as shown in FIG. 2, the flue gas cooling unit 1 comprises a flue gas condenser, in which the flue gas G is cooled by flue gas cooling liquid CL by passing it in tubes arranged in the tube heat exchanger. Flue gas G is arranged to flow outside the tubes. Heat energy is transferred from flue gas G to the flue gas cooling liquid CL through the tube walls.

In one embodiment, the flue gas cooling liquid CL is fed in the heat pump 2 and circulating it back therefrom to the flue gas cooling unit 1. In other words, heat exchanger 11 is not always necessary. District cooling fluid DCF may be circulated through the heat pump 2 with the flue gas cooling liquid CL.

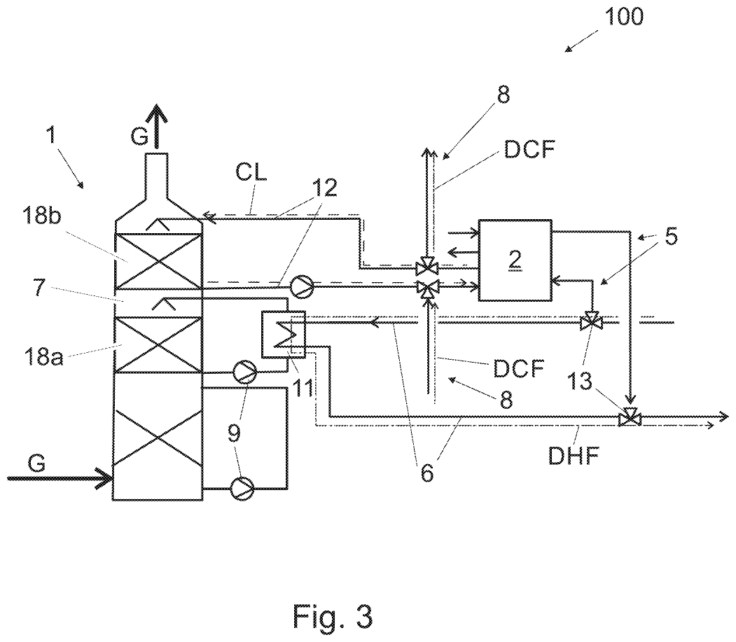

FIG. 3 is a schematic side view of a third arrangement and method for recovering heat from flue gas of a boiler.

In the flue gas scrubber 7, the flue gas is passed through one or more heat exchange zone(s) or packing zone(s). The flue gas scrubber 7 shown in FIG. 1 comprises two packing zones 18a, 18b.

In the shown embodiment, there are three scrubbing water circuits in the scrubber 7. First of the circuits is connected to a first cooling zone arranged under the first packing zone 18a, second circuit to the first packing zone 18a, and third circuit to the second packing zone 18b. However, in some embodiments the circuits of scrubbing water may be arranged differently, e.g. there may be less or more than three scrubbing water circuits, and/or less or more than two packing zones.

In one embodiment, flue gas cooling liquid CL that is fed—or at least heat energy of which is fed—in the heat pump 2 is arranged to circulate through at least the last of the heat exchange zones, that is the third heat exchange zone connected to the second packing zone 18b in the embodiment shown in FIG. 3. In another embodiment, said flue gas cooling liquid CL is arranged to circulate also another heat exchange zone, such as the second heat exchange zone connected to the first packing zone 18a.

The scrubbing water is circulated by using one or more pump(s) 9 from the flue gas scrubber 7 into a heat exchanger 11, and then back to the flue gas scrubber 7.

In one embodiment, the circulation arrangement 6 of district heating system comprises a by-pass piping 5 that is arranged for feeding only a part of the district heating fluid DHF coming from the circulation arrangement 6 of district heating system in the heat pump 2. Rest of said district heating fluid DHF is fed past the heat pump 2. In one embodiment, such as shown in FIG. 3, said rest of the district heating fluid DHF is fed to a heat exchanger 11 where it is arranged to receive heat energy from scrubbing water from the second heat exchange zone. In another embodiments, said rest of the district heating fluid DHF is fed for receiving heat energy from some other heat exchange zone.

The relation of district heating fluid DHF fed in the heat pump 2 and past the pump may be controlled by e.g. valves 13.

The amount of the district cooling fluid DCF mixed with flue gas cooling liquid is preferably controlled e.g. by valves as shown in Figures.

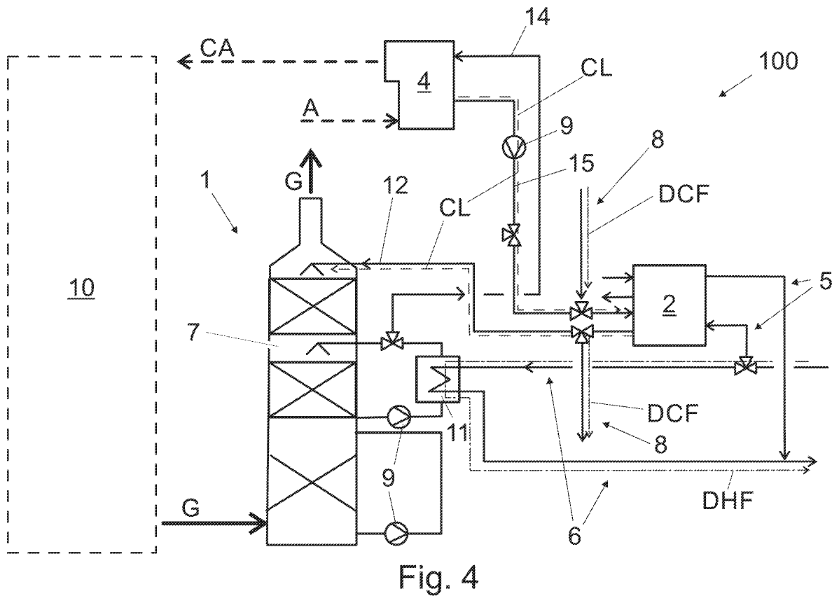

FIG. 4 is a schematic side view of a fourth arrangement and method for recovering heat from flue gas of a boiler.

In one embodiment, the arrangement comprises a combustion air humidifier 4 that is arranged for heating and moisturizing combustion air CA to be fed in the boiler 10.

The combustion air humidifier 4 improves the heat recovery capacity by increasing the moisture content of the combustion air CA and thereby increasing the moisture content of the flue gas G.

The combustion air humidifier 4 is connected to a flue gas cooling unit 1 by a feed piping 14 for receiving water therefrom and by a return channel leading the return water from the combustion air humidifier 4 back in the flue gas cooling unit 1.

The combustion air humidifier 4 receives flue gas cooling liquid CL in higher temperature for heating and humidifying said combustion air CA and returns said flue gas cooling liquid CL back in lower temperature to the flue gas cooling unit 1 by a return piping 15. The return piping 15 is arranged in relation to the heat pump 2 so that the heat pump 2 receives heat energy from flue gas cooling liquid CL returning from the combustion air humidifier 4. Said heat energy is transferred to the district heating fluid DHF in the heat pump 2.

In one embodiment, the district cooling fluid DCF coming from the district cooling system 8 is arranged to be fed in the return piping 15 and along said piping to the heat pump 2.

In one embodiment, the district cooling system 8 is connected to the piping 12 that is arranged for returning cooled flue gas cooling liquid back to the flue gas cooling unit 1, and cooled district cooling fluid DCF is taken from said piping 12 and fed in the district cooling system 8.

The invention is not limited solely to the embodiments described above, but instead many variations are possible within the scope of the inventive concept defined by the claims below. Within the scope of the inventive concept the attributes of different embodiments and applications can be used in conjunction with or replace the attributes of another embodiment or application.

The drawings and the related description are only intended to illustrate the idea of the invention. The invention may vary in detail within the scope of the inventive idea defined in the following claims.

### REFERENCE SYMBOLS

1 flue gas cooling unit
2 heat pump
3 circulation of flue gas cooling liquid
4 combustion air humidifier
5 by-pass piping of district HEATING system
6 circulation arrangement of district heating system
7 flue gas scrubber
8 circulation arrangement of district cooling system
9 pump
10 boiler
11 heat exchanger
12 piping for flue gas cooling liquid
13 valve
14 feed piping
15 return piping
16 feed of steam and/or hot water
17 return of feed
18 packing zone
19 transfer piping
100 arrangement
A air
CA combustion air
CL flue gas cooling liquid
DHF district heating fluid
DCF district cooling fluid
G flue gas

1. A method for recovering heat from flue gas of a boiler, the method comprising
passing the flue gas of the boiler though a flue gas cooling unit,
cooling the flue gas in the flue gas cooling unit, said cooling comprising transferring heat from the flue gas into a circulation of a flue gas cooling liquid,
transferring heat energy of said flue gas cooling liquid heated in the flue gas cooling unit into a heat pump,
arranging the heat pump for receiving heat energy also from a circulation arrangement of a district cooling system, wherein
the heat pump is coupled to a circulation arrangement of a district heating system, wherein the method further comprises
transferring in the heat pump heat energy received
from said cooling liquid and
from said circulation arrangement of district cooling system
into said circulation arrangement of district heating system, for
lowering the temperature of said flue gas cooling liquid and cooling fluid of said district cooling system, and
raising the temperature of heating fluid of said district heating system.

2. The method according to claim 1, comprising cooling the flue gas in a flue gas scrubber by said flue gas cooling liquid.

3. The method according to claim 1, comprising cooling the flue gas in a tube heat exchanger by said flue gas cooling liquid.

4. The method according to claim 1, comprising
feeding flue gas cooling liquid from the flue gas cooling unit into a combustion air humidifier,
heating and moisturizing combustion air to be fed in the boiler by heat energy of said flue gas cooling liquid in said combustion air humidifier, and
exiting flue gas cooling liquid cooled in the combustion air humidifier from said combustion air humidifier, the method further comprising
transferring heat energy of flue gas cooling liquid exiting the combustion air humidifier into the heat pump.

5. The method according to claim 1, comprising
feeding the flue gas cooling liquid in the heat pump and circulating it back therefrom to the flue gas cooling unit.

6. The method according to claim 1, comprising
feeding the flue gas cooling liquid in a heat exchanger, and in the heat exchanger,
transferring heat from the flue gas cooling liquid into a transfer liquid circulating between the heat exchanger and the heat pump.

7. The method according to claim 1, wherein
the heat pump is an absorption heat pump.

8. The method according to claim 7, comprising
feeding steam and/or hot water in a generator of the AHP for driving the AHP.

9. The method according to claim 1, comprising
feeding all the district heating fluid coming from the circulation arrangement of district heating system in the heat pump.

10. The method according to claim 1, comprising
feeding only a part of the district heating fluid coming from the circulation arrangement of district heating system in the heat pump, and
feeding rest of said district heating fluid past the heat pump.

11. An arrangement for recovering heat from flue gas of a boiler, the arrangement comprising
a flue gas cooling unit, configured to cool the flue gas with a flue gas cooling liquid,
a heat pump coupled to
the flue gas cooling unit,
a circulation arrangement of a district cooling system, and
a circulation arrangement of a district heating system,
the heat pump arranged to receive
flue gas cooling liquid heated in said flue gas cooling unit,
district cooling fluid from the circulation arrangement of a district cooling system,
district heating fluid from the circulation arrangement of a district heating system,
the heat pump configured for
receiving heat energy from the flue gas cooling liquid,
receiving heat energy from the district cooling fluid, and
raising temperature of the district heating fluid.

12. The arrangement according to claim 11, wherein the flue gas cooling unit comprises a flue gas scrubber or a flue gas condenser.

13. The arrangement according to claim 11, comprising
a combustion air humidifier arranged for heating and moisturizing combustion air to be fed in the boiler, wherein
the combustion air humidifier is connected to the the flue gas cooling unit by a feed piping for receiving flue gas cooling liquid in higher temperature for heating said combustion air,
the combustion air humidifier being arranged for returning said flue gas cooling liquid in lower temperature back to the flue gas cooling unit by a return piping, wherein
the heat pump is arranged in relation to the return piping for receiving heat energy therefrom and transfer said heat energy to the district heating fluid.

14. The arrangement according to claim 11, comprising a heat exchanger arranged for
receiving the flue gas cooling liquid from the flue gas cooling unit and/or the combustion air humidifier, and
transferring heat from the flue gas cooling liquid into a transfer liquid arranged to circulate between the heat exchanger and the heat pump.

15. The arrangement according to claim 11, wherein the heat pump is an absorption heat pump.

16. The arrangement according to claim 11, wherein the circulation arrangement of district heating system is connected to the heat pump for circulating all the district heating fluid through the heat pump.

17. The arrangement according to claim 11, wherein the circulation arrangement of district heating system comprises a by-pass piping arranged for feeding only a part of the district heating fluid coming from the circulation arrangement of district heating system in the heat pump.
